(19) United States
(12) Patent Application Publication
(10) Pub. No.: US 2005/0026701 A1
(43) Pub. Date: Feb. 3, 2005

(54) Method and apparatus to add functionality to gaming devices

(76) Inventor: Fathy Yassa, Soquel, CA (US)

Correspondence Address: Fathy Yassa, 4439 Esta Lane, Soquel, CA, 95073, US

(21) Appl. No.: 10/776,629

(22) Filed: Feb. 9, 2004

Related U.S. Application Data
(60) Provisional application No. 60/446,404, filed on Feb. 12, 2003.

(51) Int. Cl. A63F 13/00

(52) U.S. Cl. 463/44

(57) ABSTRACT

A smart cartridge configured to add downloading and streaming capabilities to a gaming unit.

### CLAIM OF PRIORITY

This Application claims priority from USPTO provisional application No. 60/446,404 filed on Feb. 12, 2003 and incorporates said application by reference as if fully set forth herein. This application also incorporates by reference the applications entitled METHOD AND APPARATUS FOR A PROGRAMMABLE HAND HELD MULTI-MEDIA DEVICE and METHOD AND APPARATUS FOR EXTENDING THE FUNCTIONALITY OF OFF-LINE WIRELESS DEVICE STORAGE FOR WIRELESS MULTI-MEDIA DEVICES both filed contemporaneously with this instant application.

### BACKGROUND

The early 1980's and beyond has seen a plethora of dedicated gaming devices or consoles for the home market. Such multi-national corporations as Sony, Microsoft, and Atari have each produced multiple gaming units with varying levels of success. These gaming devices are essentially dedicated computers optimized for the needs of games. Such optimization might include sophisticated and fast 3D rendering with extremely high polygon counts and frame-rates.

The latter part of the 1980's and early 1990's has seen the introduction of the hand held gaming device. These consoles were similar to the home gaming consoles with the notable difference that hand held gaming consoles added a built in display unit and were smaller Beyond the built in display unit and overall size the gaming consoles were essentially identically. Each device was essentially a microprocessor, read only memory (ROM), random access memory (RAM), a means of receiving user input, and a means of loading software into the device.

Most devices used cartridge to load the game into the gaming device. FIG. 1 illustrates a traditional cartridge. The cartridge was essential a ROM module (110) containing the program to be executed by the gaming device, a connection module 120, and a protective case 130. The benefit of the cartridge system was that it was substantially faster and more reliable that the tape-drive systems of the time. Disk drives or hard drives would have been prohibitively expensive during this time period and would have required the additional software, to wit: an operating system which would have needlessly complicated the system and increased expense.

However, the system is not without flaws. The most notable flaw is that the cartridges are static. As a practical matter, the software contained within the cartridge cannot be modified or upgraded, thus necessitating that the consumer purchase a new and separate cartridge for each game. Additionally, each time the consumer changes games, the cartridge must be removed and replaced with another cartridge. This constant component shuffling often caused equipment stress and fatigue, thus shortening the life of both the cartridges and the gaming console. Finally, the cartridges were not cross platform compatible. A game written for one system would not work on another system.

The device herein disclosed solves these various limitations by the creation of a smart, reprogrammable cartridge.

### BRIEF SUMMARY OF THE INVENTION

The invention herein referenced relates to a smart cartridge for a gaming unit which adds functionality to the gaming unit. Through the additional of wireless technology as well as additional computing power, the gaming unit is converted into a unit which has downloading and streaming capabilities.

### BRIEF DESCRIPTION OF THE DRAWINGS

Figure illustrates a traditional cartridge.

FIG. 2 illustrates the smart cartridge

FIG. 3 illustrates a flow diagram of one embodiment of the invention

### DETAILED DESCRIPTION OF THE EMBODIMENTS

The invention herein disclosed describes an exemplary smart cartridge which adds functionality to the gaming modules, including, but not limited to streaming, downloading, internet connectivity, and bi-directional communications.

For purposes of this disclosure, a smart cartridge is a cartridge which can easily be reprogrammed by the end-user.

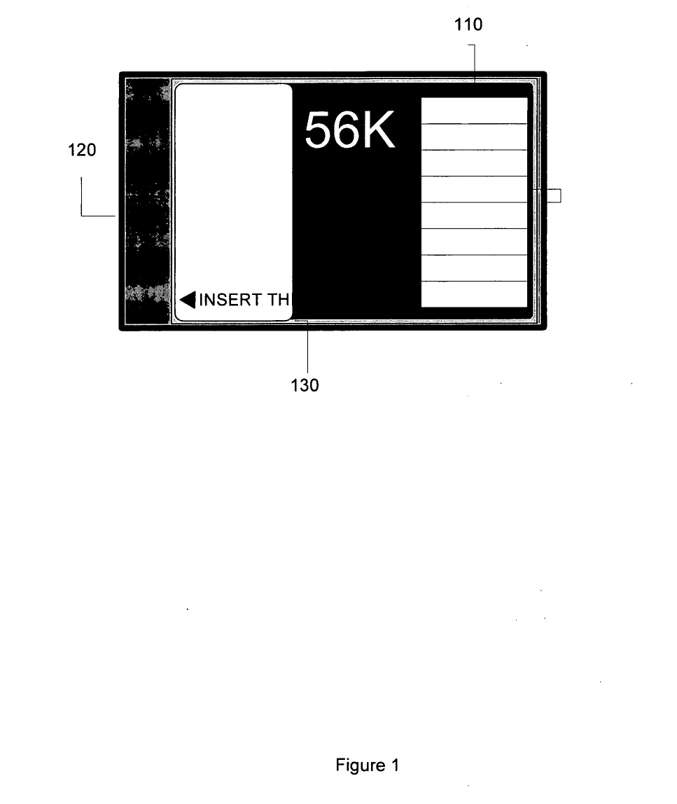

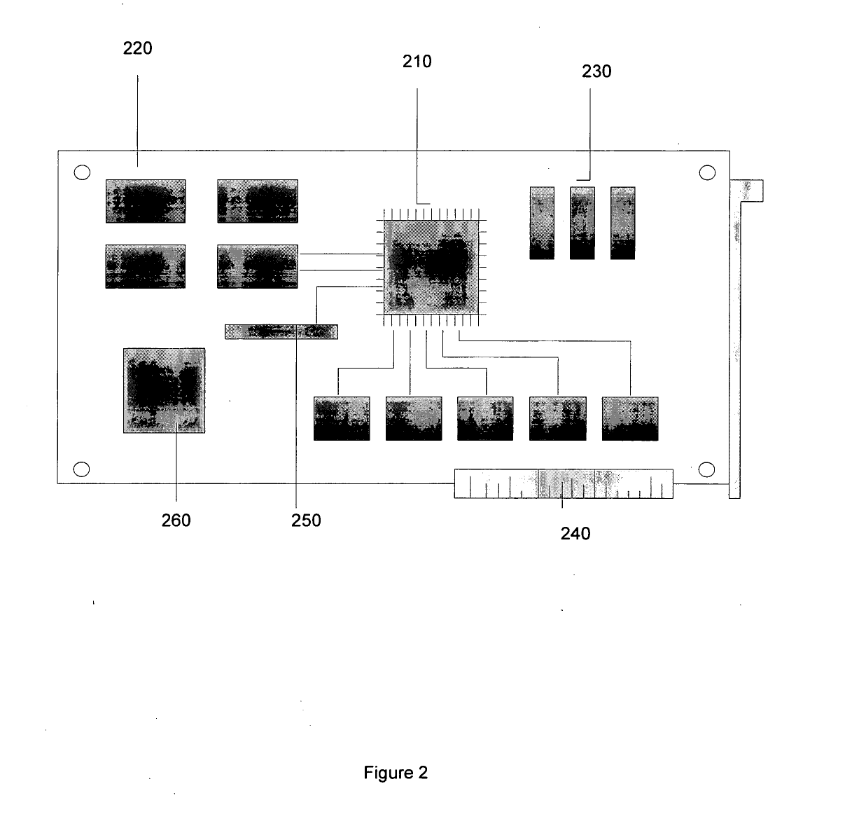

FIG. 2 illustrates one embodiment of the invention, comprising a microprocessor 210, one or more memory modules configured as read only memory 220, one or more memory modules configured as random access memory 230, software connectivity to the gaming device 240, and connectivity to a content source 250. The connectivity to the content source may be via a wired or wireless method such as 802.11 wi-fi. In the specific case of a wireless connection via wi-fi, the smart cartridge can directly connect to the internet via an internet “hot spot”. Such a connection will permit the cartridge to download or stream content directly from the internet.

In a further embodiment of the invention, the smart cartridge includes a mass storage device 260 optimized for downloading, streaming, and storing multi-media data. In yet a further embodiment of the invention, the smart cartridge includes a removable media device optimized for downloading, streaming, or simply storing multi-media data. Either storage device will also permit local playback of the stored content.

The smart cartridge will enable new functionality to the system, including bi-directional, real-time communication with a global decentralized network such as the public internet which will facilitate on-line games, multi-user on-line games, streaming, downloads, instant messengering, and Voice over IP.

The invention herein disclosed is exemplary because it provides cross-platform compatibility through the use of one or more translation programs. In one embodiment of the invention, the end-user downloads a program configured to operate in the native environment of the smart cartridge independent of gaming platform. The end-user also downloads a translation program, if not already resident in the smart cartridge. The program executes on the microprocessor of the smart cartridge. The translation program converts the output of the executable file into commands understandable by the gaming unit. This permits the game developer to reduce costs by writing for one platform.

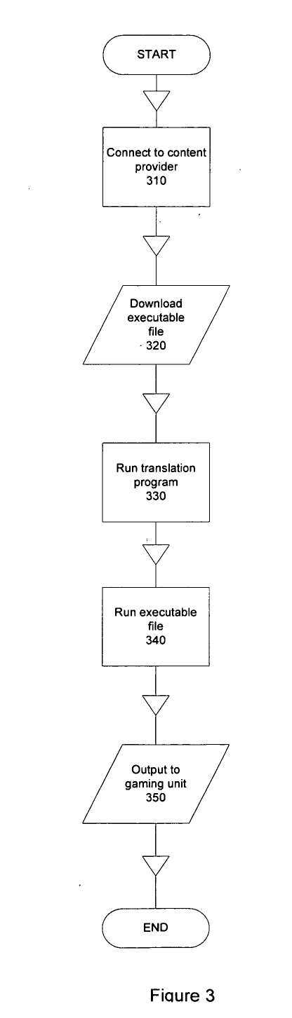

FIG. 3 illustrates the above embodiment. At Step 310, the smart cartridge connects to the content provider and downloads a file to be executed at step 320. At step 330 a translation program is executed which permits the gaming unit to receive commands from the smart cartridge in a format native to the gaming unit. The executable file is run at step 340 and the translated output send to the gaming unit at step 350.

In another embodiment of the invention, the smart cartridge receives content in the native format of the destination gaming device. In such an embodiment, the smart cartridge acts as a memory card and permits the gaming device's microprocessor direct access to the stored content.

Because of the bi-direction communication offered by the smart cartridge, two or more persons can be connected via a global network such as the public internet and have two-way communication facilitated by such protocols as instant messengering, e-mails, games, etc.

1. A smart cartridge for gaming units, comprising one or more microprocessors, one or more memory modules configured as ROM, one or more memory modules configured as RAM, software, one or more modules configured to provide connectivity to a content source, and one or more modules configured to provide connectivity to a gaming unit.

2. The smart cartridge of claim 1 further comprising a module configured to provide mass storage.

3. The smart cartridge of claim 2 where the mass storage device is removable.

4. The smart cartridge of claim 1 where the connection to the content provider is via a wireless connection.

5. The smart cartridge of claim 1 further configured to obtain content from a decentralized network.

6. The smart cartridge of claim 5 where the content is streamed.

7. The smart cartridge of claim 5 where the content is downloaded.

8. The smart cartridge of claim 5, where the content is in a format native to the smart cartridge.

9. The smart cartridge of claim 5, where the content is in a format native to the destination gaming device.

10. The smart cartridge of claim 8, where the smart cartridge translates the content into a format native to the destination gaming device.
